(19) United States
(12) Patent Application Publication
(10) Pub. No.: US 2018/0078885 A1
(43) Pub. Date: Mar. 22, 2018

(54) FILTER ASSEMBLY

(71) Applicant: Caterpillar Inc., Peoria, IL (US)

(72) Inventors: Gopinath Baskaran, Tirunelveli (IN); Ravinder R. Manne, West Lafayette, IN (US); Rajendar Immanuel, Bangalore (IN); Jay S3 Underwood, West Lafayette, IN (US); Aravindhan S. Subbaiah, Madurai (IN)

(73) Assignee: Caterpillar Inc., Peoria, IL (US)

(21) Appl. No.: 15/272,880

(22) Filed: Sep. 22, 2016

(51) Int. Cl. B01D 35/30; B01D 35/00; B04B 5/00; B04B 7/02; B01D 29/52; F01M 11/03; F02F 1/24; F02F 7/00

(52) U.S. Cl. CPC B01D 35/306; B01D 35/005; B04B 5/005; B04B 7/02; F01M 2011/031; F01M 11/03; F02F 1/24; F02F 7/0002; B01D 2201/4023; B01D 29/52

(57) ABSTRACT

A modular bracket for mounting a first filter and a second filter thereon is provided. The modular bracket includes a first mount and a second mount adapted to receive the first filter and the second filter thereon respectively. The modular bracket includes a first chamber and a second chamber provided in fluid communication with the first mount and the second mount respectively. Each of the first chamber and the second chamber is adapted to receive a filtered fluid from the first filter and the second filter respectively. The modular bracket also includes a central chamber, provided in fluid communication with the first chamber and the second chamber, adapted to receive the filtered fluid from the first chamber and the second chamber. The modular bracket further includes an outlet, provided in fluid communication with the central chamber, adapted to provide an egress of the filtered fluid from the central chamber.

### TECHNICAL FIELD

The present disclosure relates to a filter assembly. More particularly, the present disclosure relates to the filter assembly associated with an engine.

### BACKGROUND

Generally, engines employ one or more oil filters, based on a size, utilization, and design requirements thereof, for continuous cleaning of engine oil during regular operation of the engine. These oil filters may be typically mounted on the engine using individual mounting arrangements for each of the oil filters. In some situations, when the engine may employ a single large oil filter, the single oil filter may exhibit performance issues including, but not limited to, limited filtration capacity, and frequent clogging in turn leading to frequent servicing.

In such situations, the single oil filter may be replaced with two or more similar oil filters, each having a capacity smaller than that of the single oil filter. However, due to space restraints around the engine, mounting of more than one smaller oil filter in place of the single large oil filter may be difficult. Also, multiple small oil filters may demand dedicated oil inlet and/or outlet lines, and individual mounting arrangements leading to increased complexity of the arrangement and a challenge to accommodate the smaller oil filters within the restricted space.

U.S. Pat. No. 4,498,898 describes a centrifugal oil cleaner assembly mounted on a support at an upper end and to depend from the support. The assembly includes a first housing member and a second housing member engaged with an upper end of the first housing member to form a chamber. The assembly includes a substantially vertical shaft mounted in the chamber. The assembly also includes a rotor carried by the shaft and within the chamber. The shaft secures the first housing member to the second housing member by a screw thread connection and to carry the weight of the first housing member and the rotor. The assembly further includes means for supplying oil to be cleaned under pressure through the second housing member to an interior of the rotor. The means include a passageway in an upper end of the shaft. The means include jets to discharge oil from the rotor into the chamber and by reaction cause the rotor to rotate. The means further include an oil outlet for removing oil from the chamber.

### SUMMARY OF THE DISCLOSURE

In an aspect of the present disclosure, a modular bracket for mounting a first filter and a second filter thereon is provided. The modular bracket includes a first mount adapted to receive the first filter thereon. The modular bracket includes a first chamber provided in fluid communication with the first mount. The first chamber is adapted to receive a filtered fluid from the first filter. The modular bracket includes a second mount adapted to receive the second filter thereon. The modular bracket includes a second chamber provided in fluid communication with the second mount. The second chamber is adapted to receive a filtered fluid from the second filter. The modular bracket also includes a central chamber provided in fluid communication with the first chamber and the second chamber. The central chamber is adapted to receive the filtered fluid from the first chamber and the second chamber. The modular bracket further includes an outlet provided in fluid communication with the central chamber. The outlet is adapted to provide an egress of the filtered fluid from the central chamber.

In another aspect of the present disclosure, a filter assembly is provided. The filter assembly includes a first filter and a second filter. The filter assembly also includes a modular bracket for mounting the first filter and the second filter thereon. The modular bracket includes a first mount adapted to receive the first filter thereon. The modular bracket includes a first chamber provided in fluid communication with the first mount. The first chamber is adapted to receive a filtered fluid from the first filter. The modular bracket includes a second mount adapted to receive the second filter thereon. The modular bracket includes a second chamber provided in fluid communication with the second mount. The second chamber is adapted to receive a filtered fluid from the second filter. The modular bracket also includes a central chamber provided in fluid communication with the first chamber and the second chamber. The central chamber is adapted to receive the filtered fluid from the first chamber and the second chamber. The modular bracket further includes an outlet provided in fluid communication with the central chamber. The outlet is adapted to provide an egress of the filtered fluid from the central chamber.

In yet another aspect of the present disclosure, an engine is provided. The engine includes an engine block and a cylinder head mounted on the engine block. The engine also includes a filter assembly having a first filter and a second filter. The filter assembly also includes a modular bracket for mounting the first filter and the second filter thereon. The modular bracket includes a first mount adapted to receive the first filter thereon. The modular bracket includes a first chamber provided in fluid communication with the first mount. The first chamber is adapted to receive a filtered fluid from the first filter. The modular bracket includes a second mount adapted to receive the second filter thereon. The modular bracket includes a second chamber provided in fluid communication with the second mount. The second chamber is adapted to receive a filtered fluid from the second filter. The modular bracket also includes a central chamber provided in fluid communication with the first chamber and the second chamber. The central chamber is adapted to receive the filtered fluid from the first chamber and the second chamber. The modular bracket further includes an outlet provided in fluid communication with the central chamber. The outlet is adapted to provide an egress of the filtered fluid from the central chamber.

Other features and aspects of this disclosure will be apparent from the following description and the accompanying drawings.

### BRIEF DESCRIPTION OF THE DRAWINGS

FIG. 1 is a partial perspective view of an exemplary engine, according to one embodiment of the present disclosure;

FIG. 2 is an exploded perspective view of a modular bracket, according to one embodiment of the present disclosure;

FIG. 3A is a top view of the modular bracket of FIG. 2 showing different axes thereof, according to one embodiment of the present disclosure;

FIGS. 3B to 3D are different cross sectional views of the modular bracket of FIG. 2, according to one embodiment of the present disclosure;

FIG. 4 is a perspective view of a filter assembly mounted on the engine of FIG. 1, according to one embodiment of the present disclosure;

FIG. 5 is a perspective view of the filter assembly mounted on the engine of FIG. 1, according to another embodiment of the present disclosure;

FIG. 6 is an exploded perspective view of the modular bracket, according to another embodiment of the present disclosure;

FIG. 7 is a perspective view of an extension bracket of the modular bracket of FIG. 6, according to one embodiment of the present disclosure;

FIG. 8 is a perspective view of the filter assembly of FIG. 6 without the extension bracket of FIG. 7 when viewed from a bottom side of the modular bracket, according to one embodiment of the present disclosure;

FIG. 9 is a perspective view of the filter assembly of FIG. 6 with the extension bracket of FIG. 7 when viewed from a bottom side of the modular bracket, according to one embodiment of the present disclosure;

FIG. 10A is a top view of the modular bracket of FIG. 6 showing different axes thereof, according to one embodiment of the present disclosure;

FIGS. 10B to 10D are different cross sectional views of the modular bracket of FIG. 6, according to one embodiment of the present disclosure;

FIG. 11 is a perspective view of the filter assembly mounted on the engine of FIG. 1, according to another embodiment of the present disclosure; and

FIG. 12 is a perspective view of the filter assembly mounted on the engine of FIG. 1, according to another embodiment of the present disclosure.

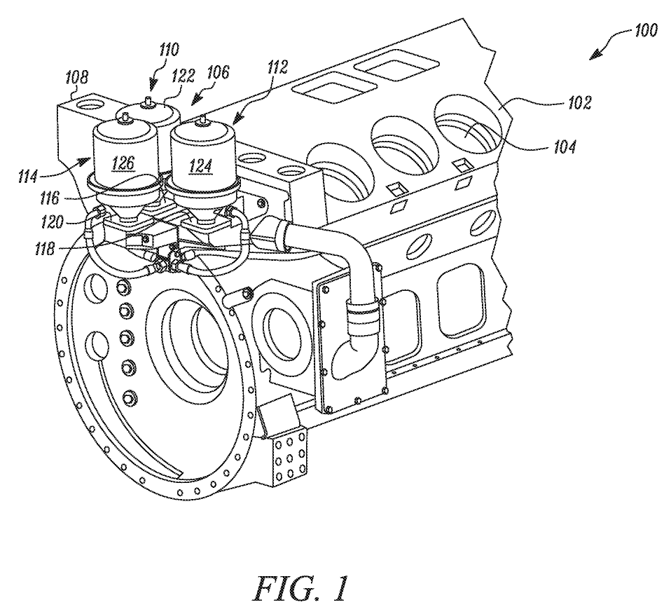

### DETAILED DESCRIPTION

Wherever possible, the same reference numbers will be used throughout the drawings to refer to the same or the like parts. Referring to FIG. 1, a portion of an exemplary engine 100 is illustrated. The engine 100 is an internal combustion engine powered by any fuel such as, natural gas, diesel, gasoline, and/or a combination thereof. In one embodiment, the engine 100 may be employed by a machine (not shown). It should be recognized that the concepts of the present disclosure may be suitably applicable to any type and configuration of the engine 100. The engine 100 and/or the machine may be used for applications including, but not limited to, power generation, transportation, construction, agriculture, forestry, aviation, marine, material handling, and waste management.

The engine 100 includes an engine block 102. The engine block 102 includes one or more cylinders 104 provided therein. The cylinders 104 may be arranged in any configuration such as inline, radial, and “V”. The engine 100 further includes a piston (not shown) movably disposed within each of the cylinders 104. Each of the pistons may be coupled to a crankshaft (not shown) of the engine 100. Energy generated from combustion of the fuel inside the cylinders 104 may be converted to rotational energy of the crankshaft by the pistons.

The engine 100 may also include a cylinder head (not shown) mounted on the engine block 102. The cylinder head may house one or more components and/or systems (not shown) of the engine 100 such as a valve train, an intake manifold, an exhaust manifold, sensors, and so on. Additionally, the engine 100 may include various other components and/or systems (not shown) such as a crankcase, a fuel system, an air system, a cooling system, a turbocharger, an exhaust gas recirculation system, an exhaust gas aftertreatment system and other peripheries.

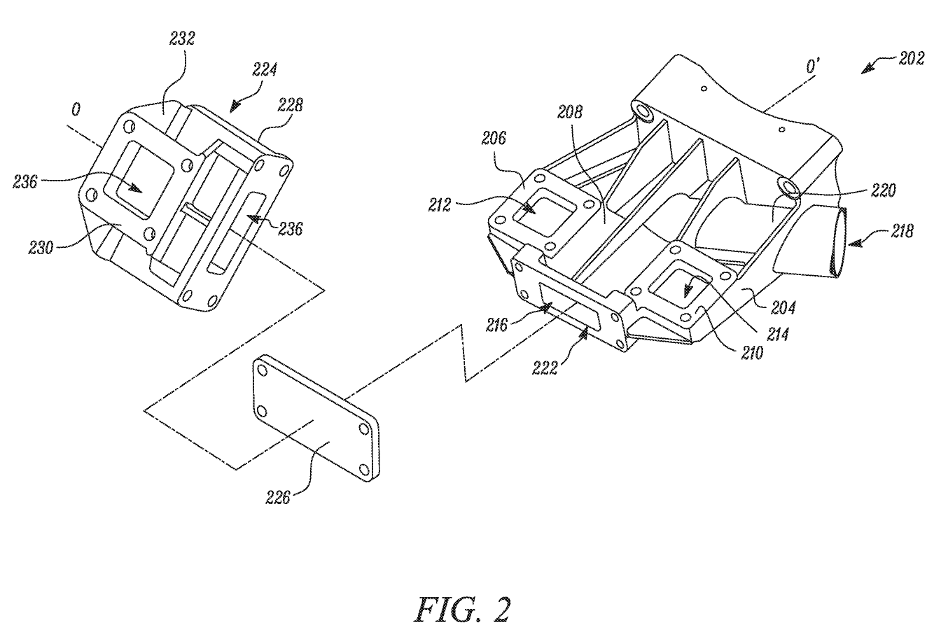

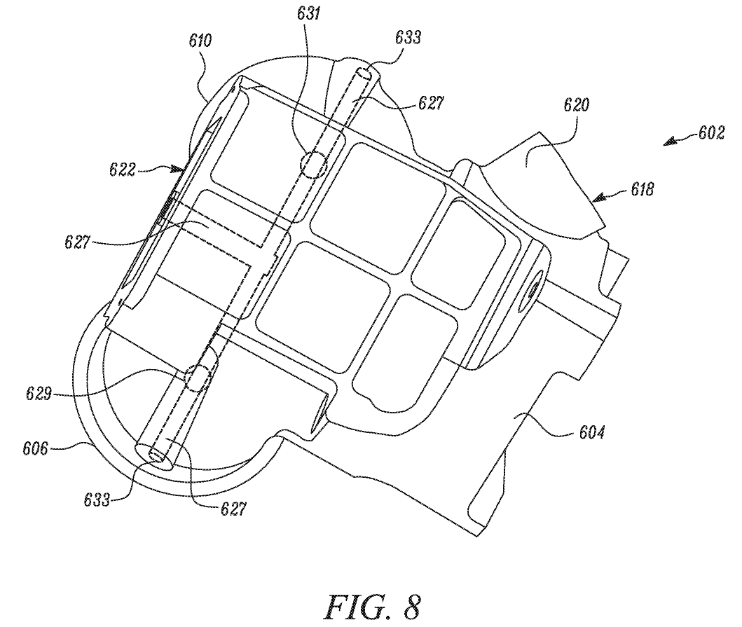

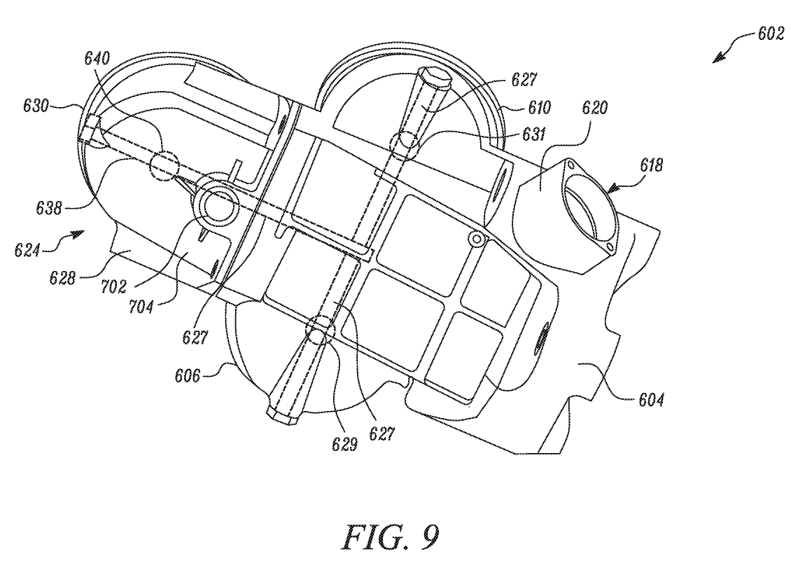

Further, the engine 100 includes a filter assembly 106 mounted thereon. The filter assembly 106 is adapted for filtration of a fluid such as engine oil associated with the engine 100. In the illustrated embodiment, the filter assembly 106 is mounted on a rear housing 108 of the engine 100. In other embodiments, the filter assembly 106 may be mounted on any other section of the engine 100 including, but not limited to, the engine block 102 and the cylinder head, without limiting the scope of the disclosure. In yet other embodiments, the filter assembly 106 may be mounted on any section of the machine including, but not limited to, a frame and an enclosure, without limiting the scope of the disclosure. The filter assembly 106 is adapted to mount multiple filters on the engine 100 such as a first filter 110, a second filter 112, and/or a third filter 114. The filter assembly 106 will now be explained in more detail with reference to FIGS. 2 to 12.

Referring to FIG. 2, a modular bracket 202 for the filter assembly 106 of the engine 100 is illustrated. The modular bracket 202 mounts a number of filters to the engine 100. The modular bracket 202 includes a body 204 having a hollow configuration. The body 204 includes a first mount 206 provided on a top surface 208 of the body 204. The first mount 206 receives the first filter 110 thereon. More specifically, the first mount 206 removably couples a first adapter 116 (shown in FIG. 1) of the first filter 110 thereon.

The first adapter 116 of the first filter 110 may be coupled to the first mount 206 by any method known in the art including, but not limited to, bolting, screw fitting, riveting, clamping, and adhesion. In the illustrated embodiment, the first mount 206 includes a rectangular configuration in order to match a configuration of the first adapter 116. In other embodiments, the first mount 206 may include any configuration such as a triangular configuration, a circular configuration, and so on based on the configuration of the first adapter 116.

The body 204 also includes a second mount 210 provided on the top surface 208 of the body 204. The second mount 210 receives the second filter 112 thereon. More specifically, the second mount 210 removably couples a second adapter 118 (shown in FIG. 1) of the second filter 112 thereon. The second adapter 118 of the second filter 112 may be coupled to the second mount 210 by any method known in the art including, but not limited to, bolting, screw fitting, riveting, clamping, and adhesion. In the illustrated embodiment, the second mount 210 includes a rectangular configuration in order to match a configuration of the second adapter 118. In other embodiments, the second mount 210 may include any configuration such as a triangular configuration, a circular configuration, and so on based on the configuration of the second adapter 118.

The body 204 includes a first chamber 212 having a hollow configuration. The first chamber 212 is provided in fluid communication with the first mount 206. In an assembled position of the first filter 110, the first chamber 212 receives a filtered fluid from the first filter 110. Similarly, the body 204 includes a second chamber 214 having a hollow configuration. The second chamber 214 is provided in fluid communication with the second mount 210. In an assembled position of the second filter 112, the second chamber 214 receives a filtered fluid from the second filter 112.

The body 204 includes a central chamber 216 provided therein. The central chamber 216 includes a hollow configuration. The central chamber 216 is provided in fluid communication with the first chamber 212 and the second chamber 214. Accordingly, the central chamber 216 receives the filtered fluid of the first filter 110 from the first chamber 212. Similarly, the central chamber 216 receives the filtered fluid of the second filter 112 from the second chamber 214.

The body 204 also includes an outlet 218 provided thereon. The outlet 218 is provided in fluid communication with the central chamber 216. The outlet 218 provides an egress of the filtered fluid from the central chamber 216. Additionally, in the illustrated embodiment, the body 204 includes a drain passage 220 provided between and in fluid communication with the central chamber 216 and the outlet 218. The drain passage 220 provides a passage for a flow of the filtered fluid from the central chamber 216 towards the outlet 218.

Also, the modular bracket 202 includes an opening 222 provided thereon. The opening 222 is provided in fluid communication with the central chamber 216. Additionally, the modular bracket 202 includes an extension bracket 224. The extension bracket 224 is selectively coupled to the body 204 adjacent to the opening 222 along an assembly axis O-O′. The extension bracket 224 may be coupled to the body 204 by any method known in the art including, but not limited to, bolting, screw fitting, riveting, clamping, and adhesion.

In a situation when the extension bracket 224 may be omitted, the modular bracket 202 includes a sealing element 226 such as a sealing plate. The sealing element 226 seals the opening 222 along the assembly axis O-O′ and limits egress of the filtered fluid therefrom. The sealing element 226 may be made of any metal or polymer based on application requirements. The sealing element 226 may be coupled to the body 204 and adjacent to the opening 222 by any method known in the art including, but not limited to, bolting, screw fitting, riveting, clamping, and adhesion.

The extension bracket 224 includes an extension body 228 having a hollow configuration. The extension body 228 includes an extension mount 230 provided on a top surface 232 of the extension body 228. The extension mount 230 receives the third filter 114 thereon. More specifically, the extension mount 230 removably couples a third adapter 120 (shown in FIG. 1) of the third filter 114 thereon. The third adapter 120 of the third filter 114 may be coupled to the extension mount 230 by any method known in the art including, but not limited to, bolting, screw fitting, riveting, clamping, and adhesion. In the illustrated embodiment, the extension mount 230 includes a rectangular configuration in order to match a configuration of the third adapter 120. In other embodiments, the extension mount 230 may include any configuration such as a triangular configuration, a circular configuration, and so on based on the configuration of the third adapter 120.

The extension body 228 includes an extension chamber 236 having a hollow configuration. The extension chamber 236 is provided in fluid communication with the extension mount 230. In an assembled position of the third filter 114, the extension chamber 236 receives a filtered fluid from the third filter 114. Further, in the assembled position of the extension body 228, the extension chamber 236 provides fluid communication between the extension mount 230 and the central chamber 216 via the opening 222. More specifically, the extension chamber 236 provides a passage for a flow of the filtered fluid from the extension mount 230 to the central chamber 216 via the opening 222.

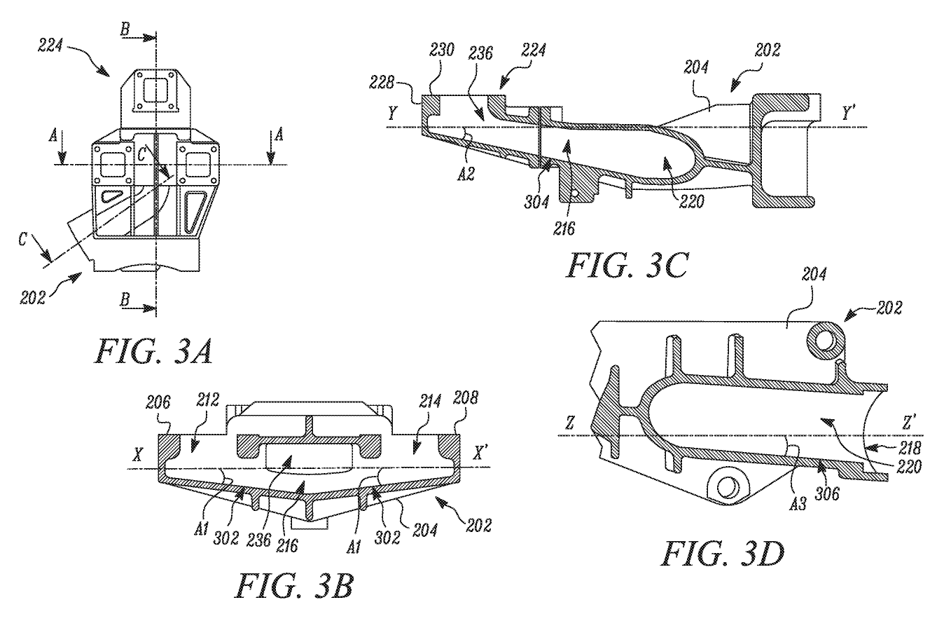

Referring to FIGS. 3B to 3D, different cross sectional views of the modular bracket 202 are illustrated. Referring to FIG. 3B, a cross sectional view of the modular bracket 202 along a section A-A (shown in FIG. 3A) is illustrated. Accordingly, the central chamber 216 includes a first slope 302 provided therein. The first slope 302 is provided in association with both the first chamber 212 and the second chamber 214. The first slope 302 provides assistance to the flow of the filtered fluid from the first chamber 212 and the second chamber 214 towards the central chamber 216. The first slope 302 defines an angle A1 with respect to a lateral axis X-X′ of the modular bracket 202. The angle A1 may include values between 5° and 10° and may vary based on application requirements.

Referring to FIG. 3C, a cross sectional view of the modular bracket 202 and the extension bracket 224 along a section B-B (shown in FIG. 3A) is illustrated. Accordingly, the central chamber 216 includes a second slope 304 provided therein. Also, the second slope 304 extends within the extension chamber 236. The second slope 304 provides assistance to the flow of the filtered fluid from the extension chamber 236 in to the central chamber 216 and further from the central chamber 216 towards the drain passage 220. The second slope 304 defines an angle A2 with respect to a longitudinal axis Y-Y′ of the modular bracket 202. The angle A2 may include values between 10° and 15° and may vary based on application requirements.

Referring to FIG. 3D, a cross sectional view of the modular bracket 202 along a section C-C (shown in FIG. 3A) is illustrated. Accordingly, the drain passage 220 includes a third slope 306 provided therein. The third slope 306 defines an angle A3 with respect to an auxiliary axis Z-Z′ of the modular bracket 202. The third slope 306 provides assistance to the flow of the filtered fluid from the drain passage 220 towards the outlet 218. The angle A3 may include values between 10° and 15° and may vary based on application requirements.

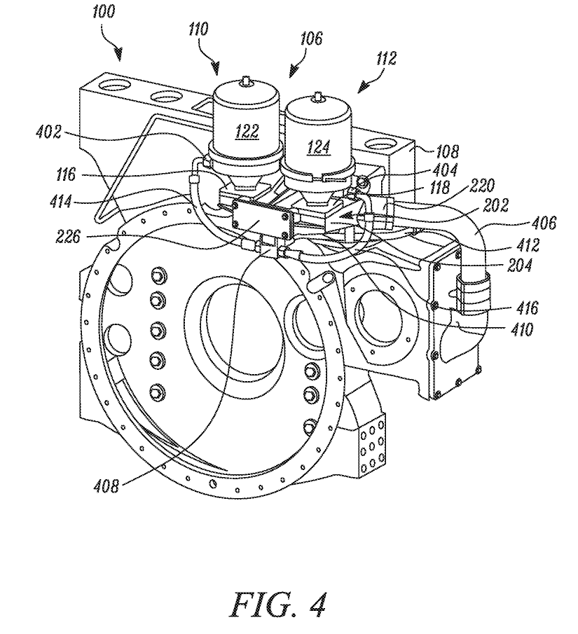

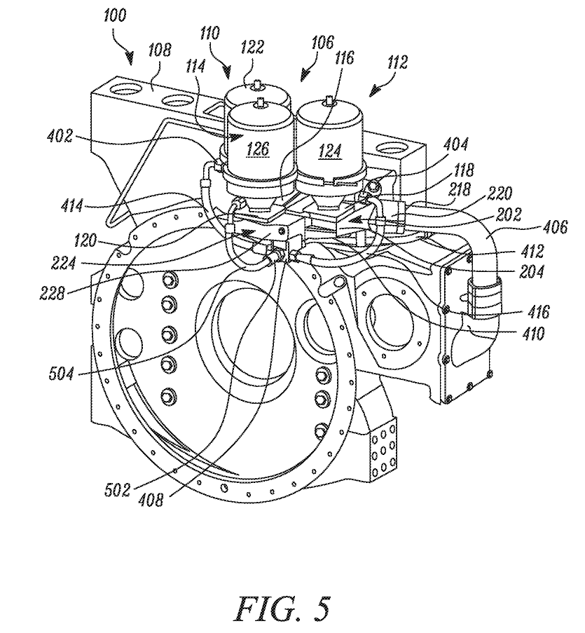

Referring to FIG. 4, the first filter 110 includes a first inlet 402 provided on the first adapter 116. Also, the second filter 112 includes a second inlet 404 provided on the second adapter 118. Further, the third filter 114 includes a third inlet 502 (shown in FIG. 5) provided on the third adapter 120. Each of the first, second, and third inlet 402, 404, 502 receives the fluid therethrough within each of the first, second, and third filter 110, 112, 114 respectively for filtration thereof. In the illustrated embodiment, each of the first, second, and third filter 110, 112, 114 is a centrifugal type oil filter adapted for filtration of the fluid such as the engine oil associated with the engine 100. In other embodiments, each of the first, second, and third filter 110, 112, 114 may be any other type of a filter associated with the engine 100 such as a fuel filter.

As shown in FIG. 4, the filter assembly 106 is mounted on the engine 100 along with the modular bracket 202, the first filter 110 and the second filter 112. Also, the opening 222 of the body 204 is sealed using the sealing element 226. The body 204 may be mounted to the engine 100 by any method known in the art including, but not limited to, bolting, screw fitting, riveting, and welding. Further, the outlet 218 of the modular bracket 202 is coupled to a drain pipe 406 associated with the engine 100. The drain pipe 406 transfers the filtered fluid from the modular bracket 202 to the engine 100.

Additionally, the body 204 includes a distribution unit 408 provided on a bottom surface 410 thereof. The distribution unit 408 receives a flow of the fluid from the engine 100. More specifically, the distribution unit 408 receives the flow of the fluid from a fluid pump (not shown) associated with the engine 100 via a main inlet line 412. The distribution unit 408 further distributes and provides the distributed flow of the fluid to each of the first filter 110 and the second filter 112. The first filter 110 receives the distributed flow of the fluid via a first inlet line 414 coupled between the distribution unit 408 and the first inlet 402. Similarly, the second filter 112 receives the distributed flow of the fluid via a second inlet line 416 coupled between the distribution unit 408 and the second inlet 404.

In another embodiment, referring to FIG. 5, the filter assembly 106 includes the extension bracket 224 coupled to the body 204 of the modular bracket 202. Also, the third filter 114 is mounted on the extension bracket 224. In such a situation, the sealing element 226 is omitted. Further, an extension inlet line 504 is coupled between the distribution unit 408 and the third inlet 502. The extension inlet line 504 provides the distributed flow of the fluid to the third filter 114.

It should be noted that the distribution unit 408 described herein is merely exemplary and optional. In other embodiments, each of the first, second, and/or third filter 110, 112, 114 may receive the flow of the fluid via individual inlet lines (not shown). The individual inlet lines may be coupled between the engine 100 or the fluid pump, and the first, second, and/or third inlet 402, 404, 502 of the first, second, and/or third filter 110, 112, 114 respectively, based on application requirements.

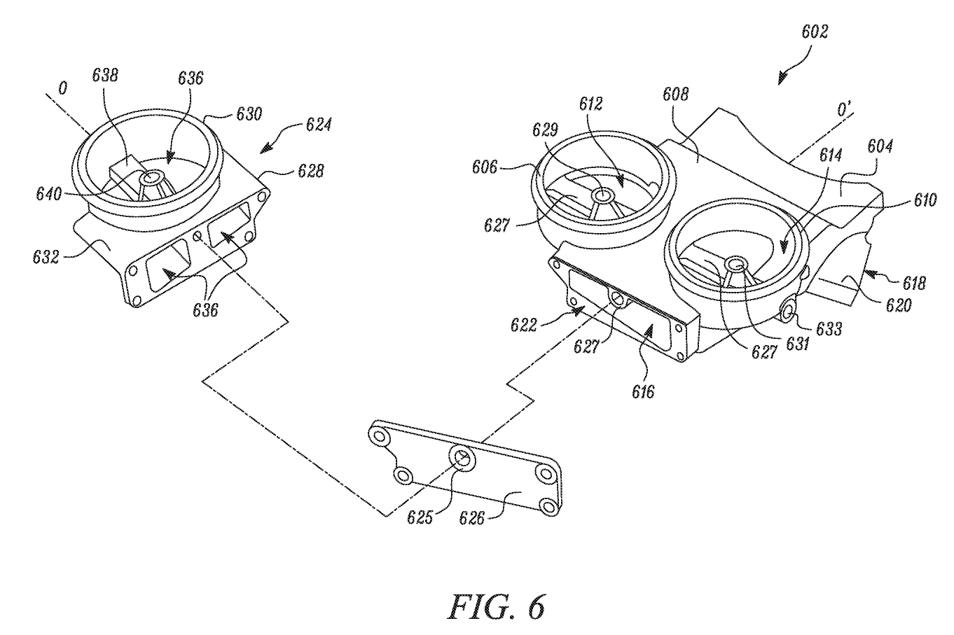

Referring to FIGS. 6 to 12, another embodiment of the modular bracket 602 for the filter assembly 106 of the engine 100 is illustrated. The modular bracket 602 is substantially similar in configuration to that of the modular bracket 202 described in relation to FIGS. 2 to 5. More specifically, referring to FIG. 6, the modular bracket 602 includes the body 604 having the hollow configuration. The body 604 includes the first mount 606 provided on the top surface 608 of the body 604. The first mount 606 receives the first filter 110 thereon. More specifically, the first mount 606 removably couples a first housing 122 (shown in FIG. 1) of the first filter 110 thereon.

The first housing 122 of the first filter 110 may be coupled to the first mount 606 by any method known in the art including, but not limited to, bolting, screw fitting, riveting, clamping, and adhesion. In the illustrated embodiment, the first mount 606 includes a circular configuration in order to match a configuration of the first housing 122. In other embodiments, the first mount 606 may include any configuration such as a rectangular configuration, an oval configuration, and so on based on the configuration of the first housing 122.

The body 604 also includes the second mount 610 provided on the top surface 608 of the body 604. The second mount 610 receives the second filter 112 thereon. More specifically, the second mount 610 removably couples a second housing 124 of the second filter 112 thereon. The second housing 124 of the second filter 112 may be coupled to the second mount 610 by any method known in the art including, but not limited to, bolting, screw fitting, riveting, clamping, and adhesion. In the illustrated embodiment, the second mount 610 includes a circular configuration in order to match a configuration of the second housing 124. In other embodiments, the second mount 610 may include any configuration such as a rectangular configuration, an oval configuration, and so on based on the configuration of the second housing 124.

The body 604 includes the first chamber 612 provided in fluid communication with the first mount 606. The first chamber 612 receives the filtered fluid from the first filter 110. Similarly, the body 604 includes the second chamber 614 provided in fluid communication with the second mount 610. The second chamber 614 receives the filtered fluid from the second filter 112. The body 604 includes the central chamber 616 provided in fluid communication with the first chamber 612 and the second chamber 614. Accordingly, the central chamber 616 receives the filtered fluid of the first filter 110 from the first chamber 612. Similarly, the central chamber 616 receives the filtered fluid of the second filter 112 from the second chamber 614.

The body 604 also includes the outlet 618 provided in fluid communication with the central chamber 616. The outlet 618 provides the egress of the filtered fluid from the central chamber 616. Additionally, in the illustrated embodiment, the body 604 includes the drain passage 620 provided between and in fluid communication with the central chamber 616 and the outlet 618. The drain passage 620 provides the passage for the flow of the filtered fluid from the central chamber 616 towards the outlet 618.

Also, the modular bracket 602 includes the opening 622 provided thereon. The opening 622 is provided in fluid communication with the central chamber 616. The modular bracket 602 also includes the sealing element 626 such as the sealing plate. The sealing element 626 seals the opening 622 along the assembly axis O-O′ and limits egress of the filtered fluid therefrom. Additionally, the modular bracket 602 includes an inlet 625 provided thereon.

More specifically, the inlet 625 is provided on the sealing element 626. The inlet 625 receives the fluid within the modular bracket 602 for filtration thereof. Also, the modular bracket 602 includes a channel 627 provided within the body 604. The channel 627 is provided in fluid communication with the inlet 625. Further, the channel 627 includes a first port 629 provided in association with the first mount 606. The first port 629 receives a central shaft/rotor (not shown) of the first filter 110. The channel 627 also includes a second port 631 provided in association with the second mount 610. The second port 631 receives a central shaft/rotor of the second filter 112.

Accordingly, the channel 627 provides the flow of the fluid in to the first filter 110 and the second filter 112 through the first port 629 and the second port 631 respectively. Additionally, the channel 627 includes one or more apertures 633 provided on the body 604. The apertures 633 may be sealed using any sealing method in order to limit egress of the fluid therethrough. In some situations, based on application requirements, the aperture 633 may provide the inlet to receive the fluid within the channel 627. In such situations, the inlet 625 provided on the sealing element 626 may be omitted or sealed.

Additionally, the modular bracket 602 includes the extension bracket 624. The extension bracket 624 selectively couples to the body 604 adjacent to the opening 622 along the assembly axis O-O′. The extension bracket 624 may be coupled to the body 604 by any method known in the art including, but not limited to, bolting, screw fitting, riveting, clamping, and adhesion. In such a situation, the sealing element 626 may be omitted. The extension bracket 624 includes the extension body 628 having the extension mount 630 provided on the top surface 632 of the extension body 628. The extension mount 630 receives the third filter 114 thereon. More specifically, the extension mount 630 removably couples a third housing 126 (shown in FIG. 1) of the third filter 114 thereon.

The third housing 126 of the third filter 114 may be coupled to the extension mount 630 by any method known in the art including, but not limited to, bolting, screw fitting, riveting, clamping, and adhesion. In the illustrated embodiment, the extension mount 630 includes a circular configuration in order to match a configuration of the third housing 126. In other embodiments, the extension mount 630 may include any configuration such as a rectangular configuration, an oval configuration, and so on based on the configuration of the third housing 126.

The extension body 628 includes the extension chamber 636 provided in fluid communication with the extension mount 630. In the assembled position of the third filter 114, the extension chamber 636 receives the filtered fluid from the third filter 114. Further, in the assembled position of the extension body 628, the extension chamber 636 provides fluid communication between the extension mount 630 and the central chamber 616 via the opening 622. More specifically, the extension chamber 636 provides the passage for the flow of the filtered fluid from the extension mount 630 to the central chamber 616 via the opening 622.

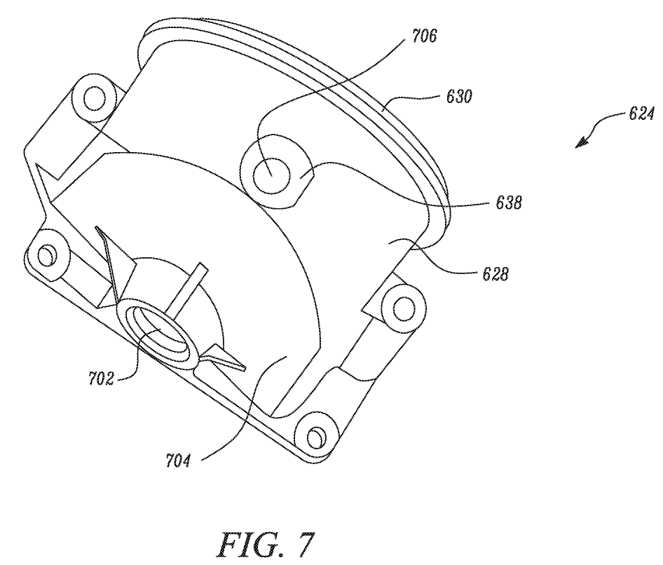

Referring to FIG. 7, the extension bracket 624 includes an extension inlet 702 provided thereon. More specifically, the extension inlet 702 is provided on a bottom surface 704 of the extension body 628. The extension inlet 702 receives the fluid within the extension bracket 624 for filtration thereof. Referring to FIG. 6, the extension bracket 624 includes an extension channel 638 provided within the extension body 628. The extension channel 638 is provided in fluid communication with the extension inlet 702. Further, the extension channel 638 includes an extension port 640 provided in association with the extension mount 630. The extension port 640 receives a central shaft/rotor (not shown) of the third filter 114.

In the assembled position of the extension body 628, the extension channel 638 is coupled to the channel 627 of the body 604 adjacent to the opening 622. Accordingly, the extension channel 638 provides the flow of the fluid in to the third filter 114 via the extension port 640, and the first filter 110 and the second filter 112 through the channel 627 and the first port 629 and the second port 631 respectively. Referring to FIG. 7, additionally, the extension channel 638 includes one or more apertures 706 provided on the extension body 628. The aperture 706 may be sealed using any sealing method in order to limit egress of the fluid therethrough. In some situations, based on application requirements, the aperture 706 may provide the inlet to receive the fluid within the extension channel 638 and the channel 627. In such situations, the extension inlet 702 provided on the bottom surface 704 of the extension body 628 may be omitted or sealed.

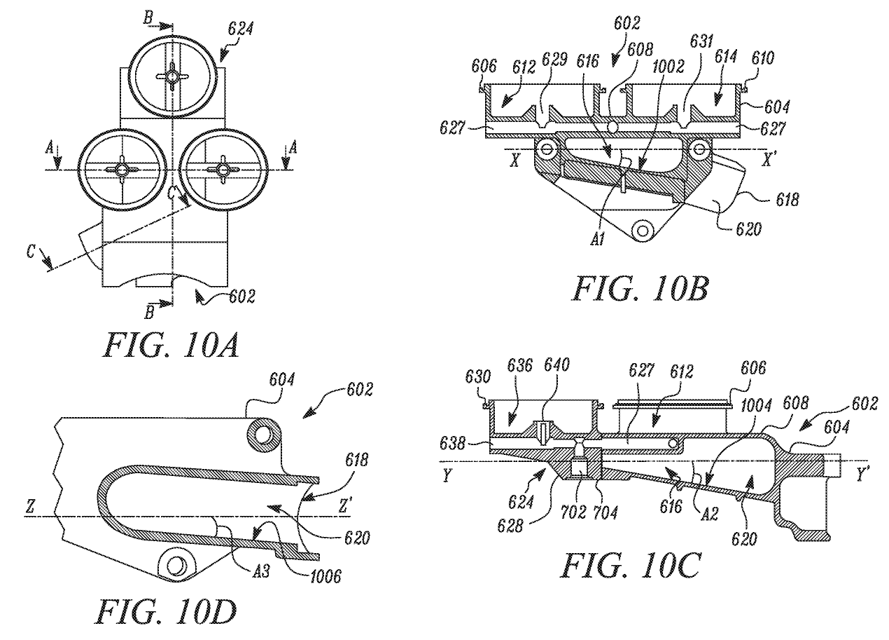

Referring to FIGS. 10B to 10D, different cross sectional views of the modular bracket 602 are illustrated. Referring to FIG. 10B, a cross sectional view of the modular bracket 602 along a section A-A (shown in FIG. 10A) is illustrated. Accordingly, the central chamber 616 includes the first slope 1002 provided in association with both the first chamber 612 and the second chamber 614. The first slope 1002 defines the angle A1 with respect to a lateral axis X-X′ of the modular bracket 602. The angle A1 may include values between 5° and 10° and may vary based on application requirements.

Referring to FIG. 10C, a cross sectional view of the modular bracket 602 and the extension bracket 624 along a section B-B (shown in FIG. 10A) is illustrated. Accordingly, the central chamber 616 includes the second slope 1004 provided therein. Also, the second slope 1004 extends within the extension chamber 636. The second slope 1004 defines the angle A2 with respect to a longitudinal axis X-X′ of the modular bracket 602. The angle A2 may include values between 10° and 15° and may vary based on application requirements.

Referring to FIG. 10D, a cross sectional view of the modular bracket 602 along a section C-C (shown in FIG. 10A) is illustrated. Accordingly, the drain passage 620 includes the third slope 1006 provided therein. The third slope 1006 defines the angle A3 with respect to an auxiliary axis Z-Z′ of the modular bracket 602. The angle A3 may include values between 10° and 15° and may vary based on application requirements.

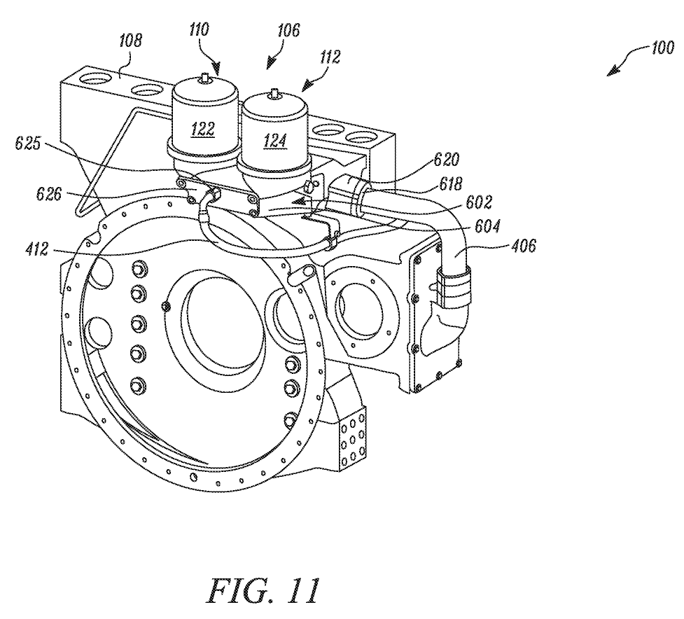

Referring to FIG. 11, the filter assembly 106 is mounted on the engine 100 along with the modular bracket 602, the first filter 110 and the second filter 112. Also, the opening 622 of the body 604 is sealed using the sealing element 626. The outlet 618 of the modular bracket 602 is coupled to the drain pipe 406 associated with the engine 100. The drain pipe 406 transfers the filtered fluid from the modular bracket 602 to the engine 100. The inlet 625 is coupled to the main inlet line 412 in order to receive the flow of the fluid from the fluid pump associated with the engine 100. The fluid is further distributed between the first filter 110 and the second filter 112 by the channel 627.

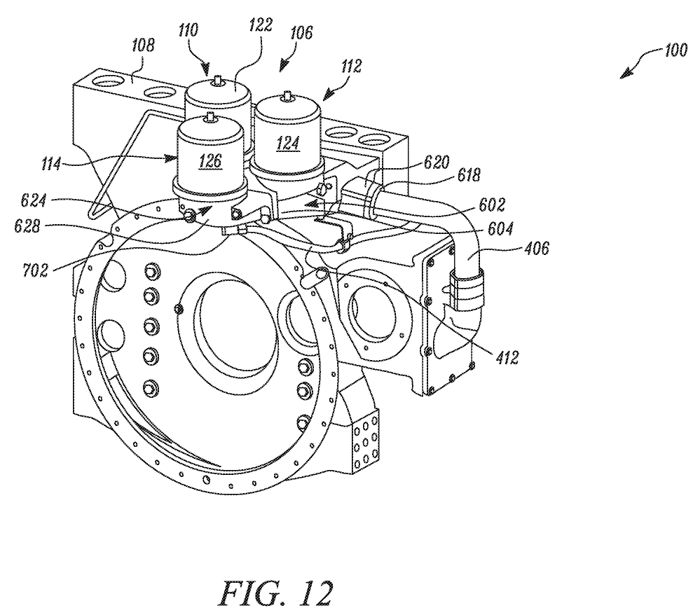

In another embodiment, referring to FIG. 12, the filter assembly 106 includes the extension bracket 624 coupled to the body 604 of the modular bracket 602. Also, the third filter 114 is mounted on the extension bracket 624. In such a situation, the sealing element 626 is omitted. Also, in such a situation, the extension inlet 702 is coupled to the main inlet line 412 in order to receive the flow of the fluid from the fluid pump associated with the engine 100. The fluid is further distributed between the first filter 110, the second filter 112, and the third filter 114 by the extension channel 638 and the channel 627.

The modular bracket 202, 602 and the extension bracket 224, 624 may be made of any metal or polymer known in the art based on application requirements. Further, the modular bracket 202, 602 and the extension bracket 224, 624 may be manufactured using any method known in the art including, but not limited to, casting, molding, fabrication, and additive manufacturing.

### INDUSTRIAL APPLICABILITY

The present disclosure relates to the modular bracket 202, 602 of the filter assembly 106 for mounting multiple filters on the engine 100. As shown in FIGS. 4 and 11, the modular bracket 202, 602 mounts the first filter 110 and the second filter 112 of the filter assembly 106 on the engine 100. In other embodiments, as shown in FIGS. 5 and 12, the modular bracket 202, 602 mounts the third filter 114 in addition to the first filter 110 and the second filter 112 to the engine 100 via the extension bracket 224, 624.

In other embodiments, multiple extension brackets (not shown) may be coupled to the modular bracket 202, 602 for mounting additional filters (not shown) to the engine 100. Alternatively, in other embodiments, the extension bracket 224, 624 may include multiple extension mounts 230, 630 in order to mount the additional filters to the engine 100. Alternatively, in yet other embodiments, an additional modular bracket (not shown) may be mounted to the modular bracket 202, 602 in place of the extension bracket 224, 624 in order to mount the additional filters to the engine 100.

Referring to FIGS. 4 and 5, each of the first, second, and/or third filter 110, 112, 114 receives the flow of the fluid via the main inlet line 412, the distribution unit 408, the first inlet line 414, the second inlet line 416, and/or the extension inlet line 504 respectively. In other embodiments, each of the first, second, and/or third filter 110, 112, 114 may receive the flow of the fluid via the individual inlet lines (not shown) based on application requirements.

Referring to FIG. 11, the first filter 110 and the second filter 112 receive the flow of the fluid via the inlet 625, the channel 627, the first port 629, and the second port 631. Referring to FIG. 12, the first filter 110, the second filter 112, and the third filter 114 receive the flow of the fluid via the extension inlet 702, the extension channel 638, the channel 627, the first port 629, the second port 631, and the extension port 640 respectively.

Further, the first slope 302, 1002 provided within the central chamber 216, 616 provides ease of flow of the filtered fluid from the first chamber 212, 612 and the second chamber 214, 614 in to the central chamber 216, 616. The second slope 304, 1004 provided within the central chamber 216, 616 provides ease of flow of the filtered fluid from the central chamber 216, 616 towards the drain passage 220, 620. The third slope 306, 1006 provided within the drain passage 220, 620 provides ease of flow of the filtered fluid from the drain passage 220, 620 towards the outlet 218, 618.

The modular bracket 202, 602 provides a simple, modular, space effective, and cost effective method to replace a single filter with multiple filters using a single modular bracket 202, 602 with or without the extension bracket 224, 624 based on application requirements. Also, the modular bracket 202, 602 provides to vary a filtration capacity of the filter assembly 106 by varying the number of the filters. Also, the modular bracket 202 provides to directly mount the first, second, and/or the third filter 110, 112, 114 thereon along with the first, second, and/or third adapter 116, 118, 120 respectively, in turn providing plug and play functionality. Further, the modular bracket 602 provides to directly mount the first, second, and/or the third housing 122, 124, 126 thereon without the first, second, and/or third adapter 116, 118, 120 of the first, second, and/or third filter 110, 112, 114 respectively, in turn limiting an overall footprint of the filter assembly 106 around the engine 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. A modular bracket for mounting a first filter and a second filter thereon, the modular bracket comprising:
a first mount adapted to receive the first filter thereon;
a first chamber provided in fluid communication with the first mount, the first chamber adapted to receive a filtered fluid from the first filter;
a second mount adapted to receive the second filter thereon;
a second chamber provided in fluid communication with the second mount, the second chamber adapted to receive a filtered fluid from the second filter;
a central chamber provided in fluid communication with the first chamber and the second chamber, the central chamber adapted to receive the filtered fluid from the first chamber and the second chamber; and
an outlet provided in fluid communication with the central chamber, the outlet adapted to provide an egress of the filtered fluid from the central chamber.

2. The modular bracket of claim 1 further including an opening provided on the modular bracket, the opening provided in fluid communication with the central chamber.

3. The modular bracket of claim 1 further including a sealing element adapted to seal the opening.

4. The modular bracket of claim 2 further comprising an extension bracket adapted to be coupled to the modular bracket, the extension bracket including:
a extension mount adapted to receive a third filter thereon; and
a extension chamber provided in fluid communication with the extension mount, the extension chamber adapted to receive a filtered fluid from the third filter, the extension chamber adapted to provide fluid communication between the extension mount and the central chamber via the opening in an assembled position.

5. The modular bracket of claim 1 further includes a first slope provided within the central chamber.

6. The modular bracket of claim 5 further includes a second slope provided within the central chamber.

7. The modular bracket of claim 1 further includes a drain passage provided between the central chamber and the outlet.

8. The modular bracket of claim 7, wherein the drain passage is inclined at an angle with respect to an axis of the modular bracket.

9. The modular bracket of claim 1 further includes:
a first inlet provided on the first filter; and
a second inlet provided on the second filter.

10. The modular bracket of claim 1 further includes:
an inlet provided on the modular bracket, the inlet adapted to receive a fluid; and
a channel provided in fluid communication with the inlet, the channel adapted to provide a flow of the fluid from the inlet to the first filter and the second filter in an assembled position.

11. The modular bracket of claim 10, wherein the extension bracket further includes:
an extension inlet adapted to receive a fluid; and
an extension channel provided in fluid communication with the extension inlet, the extension channel adapted to provide a flow of the fluid to the third filter and the channel in the assembled position.

12. A filter assembly comprising:
a first filter;
a second filter; and
a modular bracket including:
a first mount adapted to receive the first filter thereon;
a first chamber provided in fluid communication with the first mount, the first chamber adapted to receive a filtered fluid from the first filter;
a second mount adapted to receive the second filter thereon;
a second chamber provided in fluid communication with the second mount, the second chamber adapted to receive a filtered fluid from the second filter;
a central chamber provided in fluid communication with the first chamber and the second chamber, the central chamber adapted to receive the filtered fluid from the first chamber and the second chamber; and
an outlet provided in fluid communication with the central chamber, the outlet adapted to provide an egress of the filtered fluid from the central chamber.

13. The filter assembly of claim 12 further including an opening provided on the modular bracket, the opening provided in fluid communication with the central chamber.

14. The filter assembly of claim 13 further comprising an extension bracket adapted to be coupled to the modular bracket, the extension bracket including:
a extension mount adapted to receive a third filter thereon; and
a extension chamber provided in fluid communication with the extension mount, the extension chamber adapted to receive a filtered fluid from the third filter, the extension chamber adapted to provide fluid communication between the extension mount and the central chamber via the opening in an assembled position.

15. The filter assembly of claim 12 further includes a drain passage provided between the central chamber and the outlet.

16. The filter assembly of claim 12 further includes:
a first inlet provided on the first filter; and
a second inlet provided on the second filter.

17. The filter assembly of claim 12 further includes:
an inlet provided on the modular bracket, the inlet adapted to receive a fluid; and
a channel provided in fluid communication with the inlet, the channel adapted to provide a flow of the fluid from the inlet to the first filter and the second filter in an assembled position.

18. The filter assembly of claim 17, wherein the extension bracket further includes:
an extension inlet adapted to receive a fluid; and
an extension channel provided in fluid communication with the extension inlet, the extension channel adapted to provide a flow of the fluid to the third filter and the channel in the assembled position.

19. The filter assembly of claim 12, wherein each of the first filter and the second filter is a centrifugal filter.

20. An engine comprising:
an engine block;
a cylinder head mounted on the engine block; and
a filter assembly including:
a first filter;
a second filter; and
a modular bracket including:
a first mount adapted to receive the first filter thereon;
a first chamber provided in fluid communication with the first mount, the first chamber adapted to receive a filtered fluid from the first filter;
a second mount adapted to receive the second filter thereon;
a second chamber provided in fluid communication with the second mount, the second chamber adapted to receive a filtered fluid from the second filter;
a central chamber provided in fluid communication with the first chamber and the second chamber, the central chamber adapted to receive the filtered fluid from the first chamber and the second chamber; and
an outlet provided in fluid communication with the central chamber, the outlet adapted to provide an egress of the filtered fluid from the central chamber.
